(19) United States
(12) Patent Application Publication
(10) Pub. No.: US 2007/0271002 A1
(43) Pub. Date: Nov. 22, 2007

(54) SYSTEMS AND METHODS FOR THE AUTONOMOUS CONTROL, AUTOMATED GUIDANCE, AND GLOBAL COORDINATION OF MOVING PROCESS MACHINERY

(76) Inventors: Reed L. Hoskinson, Rigbi, ID (US); Matthew O. Anderson, Idaho Falls, ID (US); Mark D. McKay, Idaho Falls, ID (US); Kevin L. Kenney, Idaho Falls, ID (US)

Correspondence Address: BATTELLE ENERGY ALLIANCE, LLC, P.O. BOX 1625, IDAHO FALLS, ID, 83415-3899, US

(21) Appl. No.: 11/419,699

(22) Filed: May 22, 2006

(51) Int. Cl. G06F 19/00

(52) U.S. Cl. 700/245

(57) ABSTRACT

A control system for controlling and coordinating a plurality of moving machines includes a global coordinator; a first subsystem controlled by the global coordinator, the first subsystem including a plurality of automated moving machines, the machines including sensors and actuators, including actuators for automated guidance and movement; and a local control system, under guidance of the global coordinator coupled to the sensors and actuators of one of the machines and configured to control automated functions for the machine, including automated guidance and movement; and an intelligent communications system configured to allow communications between the first subsystem and the global coordinator or a second subsystem.

### GOVERNMENT LANGUAGE

The United States Government has certain rights in this invention pursuant to Contract No. DE-AC07-05ID14517 between the United States Department of Energy and Battelle Energy Alliance, LLC.

### TECHNICAL FIELD

The invention relates to systems and methods for autonomously controlling machinery. More particularly, the invention relates to autonomous decision-making systems and methods to control processes being conducted by a moving machine, or a set of cooperating moving machines, and the automated spatial guidance of those moving machines.

### BACKGROUND OF THE INVENTION

In numerous application areas, the need exists for the ability to conduct intelligent, autonomous processes for remote operations such as in hazardous, hostile, extreme, and/or highly repetitive environments. These needs span application areas as diverse as, for example, deep space drilling, material transportation, agriculture, mining, and nuclear energy. Advances in many technologies, and especially computer technologies, have led to complex and sophisticated machines in these application areas that conduct complicated work processes while moving across varying environments that may often be spatially unpredictable, or may be unsafe for human habitation, or may be environmentally sensitive. Most often, operations in these work environments are conducted for extended periods of time without interruption. In order to conduct work in a more efficient manner than could be done by the human operator, and often to conduct the work more safely than with human involvement, requires that the machines be autonomous in their conduct of the work. This type of autonomous system uses the minimum amount of energy and time, and conducts the work most economically and most safely.

In order to maximize efficiency and optimize these operations, these complex machines typically should be able to operate within physical and geographic bounds, to communicate with and cooperate with other autonomous machines also working on common or global tasks, and negotiate problem solutions and make decisions to optimize the conduct of the work. These machines may need to do this work for extended periods of time without timeouts. There exists a need for the ability to conduct intelligent, autonomous processes for remote operations and in hazardous, hostile, extreme, and/or highly repetitive environments.

The Carnegie Mellon University Robotics Institute (http://www.ri.cmu.edu/) is skilled in the state-of-the-art and is conducting research on topics such as Autonomous Agricultural Spraying (to make agricultural spraying significantly cheaper, safer and more environmentally friendly through automation, such that a single operator, from a remote location, can oversee the nighttime operation of at least four spraying vehicles), on an Autonomous Helicopter (to develop a vision-guided robot helicopter which can autonomously carry out functions applicable to search and rescue, surveillance, law enforcement, inspection, mapping, and aerial cinematography, in any weather conditions and using only on-board intelligence and computing power), and an Autonomous Navigation System (to provide navigational, perception, path-planning and vehicle-following algorithms, as well as the requisite on-board sensor package for autonomous mobility, and lead the development of perception and path planning, and assist with perception and world modeling).

The Utah State University Center for Self-Organizing and Intelligent Systems (CSOIS) (http://www.csois.usu.edu/) is a multi-disciplinary research group that focuses on the design, development, and implementation of intelligent, autonomous mechatronic systems, with a recent focus on ground vehicles and robotics. CSOIS research advances the state-of-the-art in the theory, development, and application of systems that need advanced automation, autonomous operation or behavior, and intelligent decision-making and learning to achieve their objectives. They describe concepts for the future such as a conceptual plan for multiple autonomous agents to detect threats in critical locations such as nuclear reactors, power plants, and military installations. The autonomous agents share information through something like a central nervous system. There are dedicated agents that are assigned to process intercommunication messages and develop perceptions of large scale threats, while other agents plan responses and configure responses from unmanned aircraft, all-terrain robots, and even automated defense systems.

Commercial robotics companies often have intriguing company names, but have really commercialized the simplistic robotic systems. As an example, Autonomous Solutions, Inc. (ASI) (http://www.autonomoussolutions.com/index.html) claims to design and manufacture unmanned vehicles for a variety of corporate and military customers. ASI claims to have extensive experience in the automation of large and small scale vehicles and machinery with an emphasis on mission planning, sensor fusion, obstacle avoidance, multi-vehicle control, and point and click ease of use. ASI does not provide a complete solution.

The ORNL/UTK Cooperative Autonomous Robotics Research Laboratory has historically been led by Dr. Lynne Parker, an MIT graduate of the computer science and artificial intelligent laboratory (CSAIL). Links to this research are:
http://avalon.epm.ornl.gov/˜parkerle/
http://www.csm.ornl.gov/cap.html &
http://www.cs.utk.edu/˜parker/

### It should be noted that this research is very extensive in cooperative robotics and intelligent agents, but is on small development platforms.

The MIT Computer Science and Artificial Intelligence Laboratory (CSAIL) is involved in research in the development of cognitive robots that attempt to mimic human capabilities. But this work is again limited to local intelligence. Links to CSAIL are:
http://www.ai.mit.edu/projects/cognitive-robotics/asrl.html; and
http://robots.mit.edu/projects/index.html
   A founder in this area is Dr. Rodney Brookes:
http://www.csail.mit.edu/research/activities/activities.html

Leaders in the area of automated moving machinery include the Colorado School of Mines. A review of their work indicates that their works appears to be limited to single moving machinery:
http://www.mines.edu/academic/mining/research/emi/index.htm

Dr. Bob King at the Colorado School of Mines is an expert in this area, but very little information could be found on the current state of the art of his work. Contact information obtained is:
Center for Automation, Robotics and Distributed Intelligence—CARDI
Center for Commercial Applications of Combustion in Space—CCACS
Office: BB 279

In this area, an article on Australia using robots in mining was found:
http://www.sciencedaily.com/releases/2000/05/000522081404.htm

Recognized as an industry leader in robotics, iRobot Corporation emphasizes in military applications, household applications, and some research platforms. These systems may be used for swarming techniques.
http://www.irobot.com/sp.cfm?pageid=149

### SUMMARY OF THE INVENTION

Some aspects of the invention provide a control system for controlling and coordinating a plurality of moving machines, the system comprising a global coordinator; and a plurality of subsystems controlled by the global coordinator, respective subsystems including an intelligent real-time task planner including a job planner and job optimizer; intelligent communications hardware configured to allow communications between the subsystem and the global coordinator or another subsystem; an application intelligence system configured to control functions related to a specific task a machine has been given; and a local intelligence system coupled to sensors and actuators of one of the machines and configured to control automated functions for the machine.

Other aspects of the invention provide a method of controlling and coordinating a plurality of moving machines, the method comprising providing a global coordinator; controlling a plurality of subsystems using the global coordinator; and for at least one of subsystems planning and optimizing jobs; communicating between the subsystem and the global coordinator or another subsystem; controlling functions related to a specific task a machine in the subsystem has been given; and controlling automated functions for the machine.

Further aspects of the invention provide for a control system for controlling and coordinating a plurality of moving machines, the system comprising a global coordinator; a first subsystem controlled by the global coordinator, the first subsystem including a plurality of automated moving machines, the machines including sensors and actuators, including actuators for automated guidance and movement; and a local control system, under guidance of the global coordinator coupled to the sensors and actuators of one of the machines and configured to control automated functions for the machine, including automated guidance and movement; a second subsystem controlled by the global coordinator, the second subsystem including a plurality of automated moving machines, the machines of the second subsystem including sensors and actuators, including actuators for automated guidance and movement; and a second local control system, under guidance of the global coordinator coupled to the sensors and actuators of one of the machines of the second subsystem and configured to control automated functions for the machine, including automated guidance and movement; and an intelligent communications system configured to allow communications between the first subsystem and the global coordinator or the second subsystem.

### BRIEF DESCRIPTION OF THE DRAWINGS

Preferred embodiments of the invention are described below with reference to the following accompanying drawings.

FIG. 1 is a block diagram of control system architecture according to various embodiments of the invention.

FIG. 2 is a block diagram that illustrates multiple individual systems of the type shown in FIG. 1 combined into a global system.

FIG. 3 is a block diagram illustrating expandability and adaptability of the system of FIG. 1.

FIG. 4 is a block diagram in an alternative format illustrating the expandability and adaptability of the system of FIG. 1.

FIG. 5 is a block diagram of a system in accordance with a specific example relating to bulk mining.

FIG. 6 is a block diagram focusing on an individual system included in the system of FIG. 5.

FIG. 7 is a block diagram illustrating communications between a system and subsystems illustrated in FIG. 6.

FIG. 8 is a block diagram illustrating details of subsystems included in the system of FIG. 7.

FIG. 9 is a block diagram illustrating further details of subsystems included in the system of FIG. 7.

FIG. 10 is a block diagram illustrating communications between subsystems included in the system of FIG. 7.

FIG. 11 is a block diagram illustrating additional subsystems included in a subsystem of FIG. 10.

FIG. 12 is a block diagram similar to FIG. 11 but illustrating additional details for one of the subsystem shown in FIG. 11.

FIG. 13 is a block diagram illustrating further details of a subsystem of FIG. 12.

FIG. 14 is a map illustrating how FIGS. 14A and 14B are to be combined.

FIG. 14A is a portion of a block diagram illustrating a specific example employing systems and methods for the autonomous control, automated guidance, and global coordination of agricultural machinery.

FIG. 14B is a portion of a block diagram, to be combined with FIG. 14A.

### DETAILED DESCRIPTION OF THE PREFERRED EMBODIMENTS

Some aspects of the invention provide optimization of individual processes as well as global optimization. This is produced via a synergistic “whole is greater than the sum of its parts”. For example, assume a single system is optimized via local intelligence to react to its individual sensors and increase efficiency by 10%. Duplicate this system five times and one would expect a theoretical increase of 10% in each machine, for a 10% efficiency gain for the whole system. With the global coordination and robust communications of all intelligent assets' resources, each individual system is able to react and optimize on group intelligence resulting in increased global efficiency for the whole system greater than the 10% gained via local intelligence, and therefore achieving synergistic results greater than the sum of the parts.

As stated above, a problem to be solved is the need to conduct intelligent, autonomous processes for remote operations and in hazardous, hostile, extreme, and/or highly repetitive environments.

This requires that the autonomous machines, devices or components be intelligent independent agents, as a part of a system of intelligent agents, able to collaborate on the conduct of the work, and able to compensate for failures or reduced capabilities of individual agents. At the same time, this agent, or set of agents, may be operating in a local environment (overseen locally) or may be under global control, being overseen via long range communication, such as over the internet or advanced communication networks. These requirements are met in the illustrated embodiments.

The solution to this problem involves a unique machine system that fuses many autonomous control and decision making technologies with many automated guidance and cooperative work planning and work conduct technologies to carry out work processes in a most efficient and effective manner. This fusion of intelligent systems with automated robotics is a new approach to optimizing a work function.

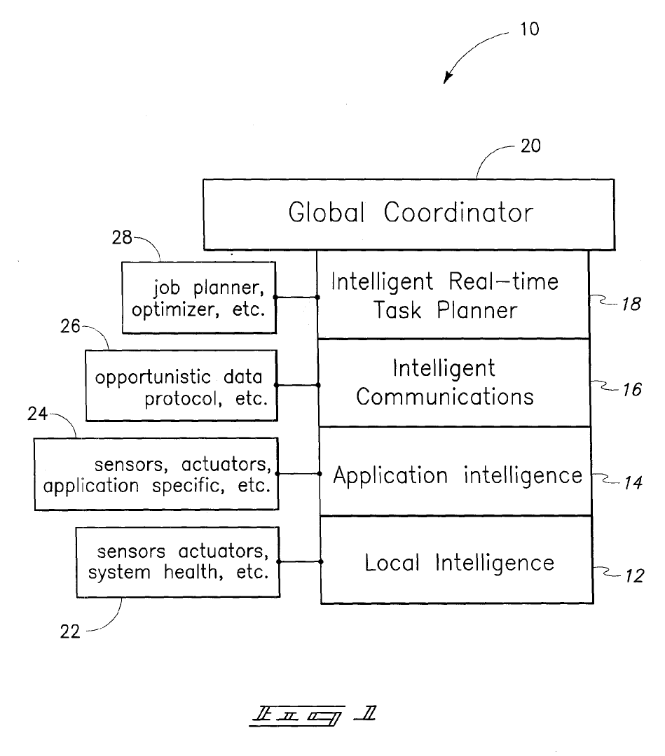

In some embodiments (see FIG. 1), the technologies fused comprise local intelligence 12, application intelligence 14, intelligent communications 16, intelligent real-time task planner 18, and a global coordinator 20, combined to create a synergistic solution. FIG. 1 illustrates this core control system architecture 10 with each layer acting upon inputs and providing appropriate outputs for a given system. For example, in FIG. 1, inputs 22 to the local intelligence include sensors, actuators, system health inputs, etc. Inputs 24 to the application intelligence 14 include sensors, actuators, application specific inputs, etc. The intelligent communications 16 can make use of an opportunistic data protocol described below, for example, or other protocols. The intelligent real-time task planner 18 can make use of a job planner, optimizer, etc.

The core system building block 10 can be duplicated as many times as necessary to fit the specific task objectives, and this collection of building blocks can also be combined to meet the overall application needs. For example System A can consist of 1 to n building blocks controlling 1 to n agents to meet a specific task objective. If an application requires multiple heterogeneous systems, then additional systems (consisting of 1 to n agents) can be combined to meet the global application objectives.

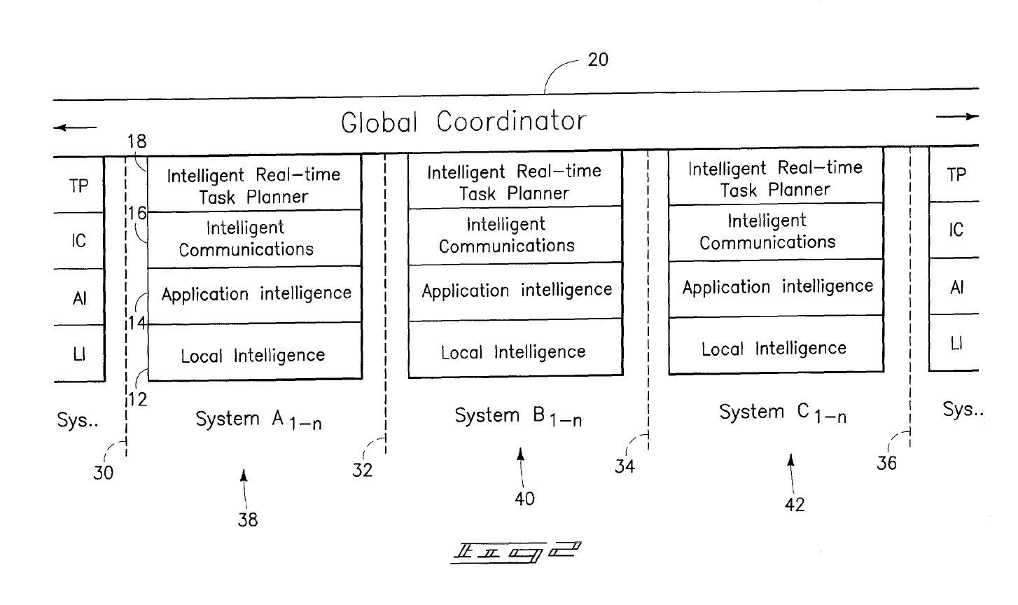

FIG. 2 depicts the individual systems combined into a global system. The boundary layers 30, 32, 34, and 36 in FIG. 2 represent physical or conceptual separations between systems 38, 40, 42, etc., illustrating the ability of systems to function independently while meeting a global objective.

A few examples will illustrate this concept. High altitude mining requires the harvesting of ore using mobile manipulation and subsequently bulk transportation. This hazardous operation is well suited to be implemented using this control system 10. System A (see FIG. 2) represents 1 to n mining extraction processes requiring local manipulation. System B represents 1 to n bulk material handling and transportation agents, such as large earth movers and mining trucks. Although geographically separated, the global coordinator oversees the coordination of extraction and material handling while the local task planner combined with the application and local intelligence layers ensure local agent objectives are met. This concept can further be applied to agriculture (e.g., multiple machines collaborating on a job, such as a fleet of combines and grain trucks working together at harvest), national border work environments (where materials are partially processed on one side of the border and transported across the border for additional processing) and environmental monitoring and clean-up operations (such as the assessment and remediation of contaminated soils by their removal and transport to a safe area) in a similar fashion.

### Local Intelligence

Local intelligence 12 is a process control center for all automated functions and controls for governing all systems local to a given system, device, or machine (agent). This building block interfaces to all sensors and systems necessary for basic function or operation, interoperable sensors, modular behavior blocks, automated task decomposition, behavior assembly, and perception to knowledge (i.e. Data fusion). Each agent is equipped with various sensor technologies to detect important phenomena in its environment, such as physical objects, chemicals, radiation, or electromagnetic signals, and is able to evaluate these into their decision making, both for making decisions about the internal work processes within each individual machine, and also for making decisions on work assignment partitioning among the agents. The local intelligence 12 is designed to appropriately navigate the local environment, protecting the agent (analogous to an operating system software kernel that protects and controls its hardware and resources) and accomplishing its individual task in an optimal fashion.

In some embodiments, the local intelligence 12 is defined by a system similar to the one disclosed in U.S. Provisional Application Ser. No. 60/174,389, filed Jan. 3, 2000, titled, “Systems and Methods for Analysis of Spatial Data,” now U.S. Pat. No. 6,865,582 to Zoran Obradovic, et al., titled “Systems and Methods for Knowledge Discovery in Spatial Data” and incorporated herein by reference.

In some embodiments, the local intelligence 12 is defined by a system similar to the one disclosed in U.S. patent application Ser. No. 418,667, filed Apr. 17, 2003, by Mark D. McKay et al., for “Auto-Steering Apparatus and Method”, now U.S. Patent Publication No. 2004/0210357, which is incorporated herein by reference.

### Application Intelligence

Residing above the local intelligence 12 is a layer referred to herein as application intelligence 14. The application intelligence 14 is responsible for controlling task-specific functions. The application intelligence 14 handles functions and controls related to the specific task that the device or agent has been given. While the local intelligence works to guide a given device through its environment, the application intelligence works to assist the device to interact with its environment, analogous to an application layer in a computer operating system. In some embodiments, the application intelligence 14 interacts with the payload and related actuators, sensors, and system parameters as necessary to accomplish an assigned task. This process may include the use of decision support systems based on techniques such as artificial intelligence, fuzzy logic, or other analytical procedures. For example, in some embodiments, optimization of settings of concaves, of rotor speed, and/or of fan speed of a combine during harvest, is performed by application-specific controls defined by application intelligence 14. In some embodiments, automated steering via a robotic system is performed by application-specific controls defined by application intelligence 14.

In some embodiments, the application intelligence 14 is defined by a system similar to the one disclosed, for example, in U.S. Pat. No. 6,591,145, by Reed L. Hoskinson et al for “Systems and Methods for Autonomously Controlling Agricultural Machinery,” which is incorporated herein by reference.

In some embodiments, the Application Intelligence 14 is defined by a system similar to the one disclosed, for example, in “Multi-Robot Automated Indoor Floor Characterization Team” published in the proceedings of the 1996 IEEE International Conference on Robotics and Automation, Minneapolis, Minn. April, 1996, which is incorporated herein by reference. This paper discusses multi-agent intelligent robotic systems collaboratively performing radiological surveys in a marsupial relationship.

In some embodiments, the application intelligence 14 is defined by a system similar to the one disclosed, for example, in U.S. patent application Ser. No. 10/888,815, filed Jul. 8, 2004 (Attorney Docket No. B-251), by Reed L. Hoskinson et al., for “Method and Apparatus for Monitoring Characteristics of a Flow Path Having Solid Components Flowing Therethrough”, now U.S. Patent Publication No. 2006/0009269, which is incorporated herein by reference.

In some embodiments, the application intelligence 14 is defined by a system similar to the one disclosed, for example, in Attorney Docket No. B-473, for “Autonomous Grain Combine Control System,” incorporated herein by reference and appended hereto as Appendix A.

### Intelligent Communications

The intelligent communications system 16 comprises algorithms, software agents, protocols, and/or transmission paths that serve to promote successful data and command transfer even when a communications link is interrupted. Communication among multiple agents may be compromised by electromagnetic fields, physical obstructions, or naturally occurring disturbances such as topographic changes. As such, the intelligent communications system is able to continually compensate for these interruptions, and take advantage of opportunities to communicate when the opportunities exist. Additionally, it is not bound to one single communications channel. The intelligent communications system 16 automatically adapts to establish the best communication link.

In some embodiments, the intelligent communications system 16 is defined by a system similar to the one disclosed, for example, in U.S. patent application Ser. No. 09/775,170, filed Feb. 1, 2001, (Attorney. Dkt. No. LIT-PI-480), by John M. Svoboda et al., for “Systems and Methods for Employing Opportunistic Data Transfer to Create a Dynamically Mobile Data Communications System,” now U.S. Patent Publication No. 2002/0104011, which is incorporated herein by reference.

### Intelligent Real-Time Task Planner

The intelligent real-time task planner or task optimizer 18 serves to oversee locally the task an agent is performing. Agents equipped with various sensors designed to detect phenomena in their environment, such as physical objects, chemicals, radiation, or changes in payload performance should be able to evaluate all provided data and modify operating parameters such as navigation paths, and make decisions about the work assignment and partitioning among like agents. A system of agents can consist of anywhere from 1 to n agents all performing like assignments. The intelligent real-time task planner 18 works to optimize the assigned tasks for each agent or device to achieve a common goal.

In some embodiments, the task planner 18 is defined by a system similar to the one disclosed, for example, in “Mobile Robotic Teams Applied to Precision Agriculture” published in the American Nuclear Society Eighth International Topical Meeting on Robotics and Remote Systems, Pittsburgh, Pa. April, 1999, and incorporated herein by reference. This publication discusses multi-agent intelligent robotic systems with a global coordinator as applied to agriculture, automated radiological surveys, soil sampling, and chemical spraying applications.

In some embodiments, the task planner 18 is defined by a system similar to the one disclosed, for example, in U.S. Pat. No. 6,865,582, issued Mar. 8, 2005, by Zoran Obradovic et al., for “Systems and Methods for Knowledge Discovery in Spatial Data,” which is incorporated herein by reference.

### Global Coordinator

While the agent, or set of agents, may be operating in a local environment, the global coordinator 20 functions to manage, coordinate, and direct given agent tasks which may or may not be related. The global coordinator is the director or the overseer of devices, agents, machines, etc., existing in the network of systems. The global coordinator provides the backbone and access to the information database. On a higher level, it performs task planning and orchestrates the operation of n groups of agents. It re-tasks, re-scopes and updates devices based on current applications or user needs. The global coordinator serves as a shared information exchange to multiple task planners 18 providing situational data, which then can be exploited by others for adaptation of their commanded tasks.

In some embodiments, the global coordinator 20 is defined by a system similar to the one disclosed, for example, in INL University Research Consortium Technology, “Intelligent Fully Autonomous Micro-Robotic Control Systems for Hazardous Waste Site Characterization” final report; Project ID #G219 10/1998, incorporated herein by reference and appended hereto as Appendix B.

In some embodiments, the global coordinator 20 is defined by a system similar to the one disclosed, for example, in “Mobile Robotic Teams Applied to Precision Agriculture” published in the American Nuclear Society Eighth International Topical Meeting on Robotics and Remote Systems, Pittsburgh, Pa. April, 1999, incorporated herein by reference. This publication discusses multi-agent intelligent robotic systems with a global coordinator as applied to agriculture, automated radiological surveys, soil sampling, and chemical spraying applications

A benefit of a system that fuses the intelligent autonomous control with the automated guidance for a planned task is that it results in an unmanned machine that is capable of carrying out a complete job function without, or with only minimal, manpower input. It is also a system which, when more than one agent is involved, is capable of intelligently cooperating and negotiating an optimum solution to the work assignment under direction of the global coordinator 20. This increased efficiency of the system saves manpower labor costs, allows for highly repeatable performance, and also reduces human exposure to dangerous work environments.

These system benefits provide value in a wide array of applications and potential applications. For example, the system has value in agricultural applications. In some embodiments, the system 10 operates a fleet of grain combines at harvest, optimizing the individual performances of the combines, optimizing the path assignments of the fleet, and optimizing the ready availability of the grain trucks into which the grain is loaded. In some embodiments, the system communicates with and optimally schedules the grain truck travel to the off-farm grain elevator so that waiting time to unload the grain truck is minimized and enough trucks are always available on the farm. Here benefits might include not only increased productivity (acres harvested/hour) and efficiency (reduced grain loss and damage) and reduced waiting time at the grain elevator and in the field, but also the benefit of being able to use unskilled labor, which is more available.

In some embodiments, the system 10 is applied in mining to operate, for example, a fleet of mineral mining machines. The system 10 is particularly beneficial, for example, if the mining machines are operating in a difficult environment, such as at a remote high elevation, where living and working conditions for human laborers are difficult, with extreme cold, and much reduced oxygen level. In some embodiments, the mined materials are transported by automatically guided vehicles to processing facilities where the processing is optimized against many different factors, such as cost of labor, value of minerals retrieved, and waste processing and handling costs.

In other embodiments, a processing facility is located at a border between two countries, to take advantage of lower labor, materials, taxes, and/or energy rates in one country compared to the other. For optimal movement of materials while being processed, communication is provided across the sites, with planning optimized for such factors as plant capacity and machine capacity. In some embodiments, these systems also plan the transport operations across the border and monitor and control the movement using opportunistic communications. In addition, in some embodiments, the system integrates GPS (e.g., the system includes a global positioning system) for tracking and enhanced security.

An environmental cleanup site may require the removal and relocation of waste materials, buried or on the surface. Not only should the robotic sensing and spatial mapping of these wastes be done with minimum human exposure, but the actual digging and accumulation of the materials in question, as well as the coordinated bulk transport of these materials to a disposal site should be planned, taking many factors into account, with the highest level of safety required.

Some embodiments provide an unmanned system, including the system 10, in the commercial sector, such as for machines that conduct agricultural work (grain combines, tractors and cultivators, fruit and nut pickers, etc.), for large earth-moving machines and pavers that autonomously build roadbeds and highway beds and airport landing strip beds and then pave them, or in mining to mine the mineral material and process it and transport it. In some embodiments, these systems 10 are used in mining operations in remote and threatening environments. Similarly, in some embodiments, the system 10 is used in government applications for national defense or homeland security, such as for surveillance, assessment and handling of unexploded ordnance or IEDs, or counter-terrorist actions, or cleanup and remediation of hazardous and radioactive sites.

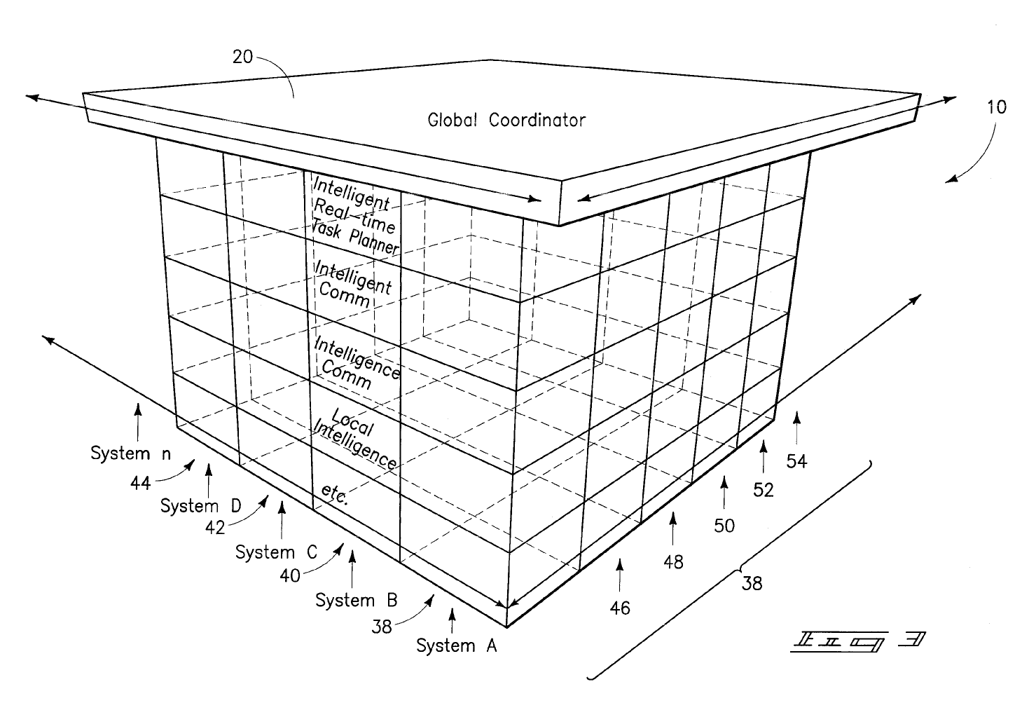

In some embodiments, illustrated in FIG. 3, the global coordinator 20 is expandable and adaptable in that it can automatically and intelligently expand its coordination to any number of systems (e.g., 38, 40, 42, 44) or subsystems (e.g., 46, 48, 50, 52, 54, etc.). After information about a system or subsystem has been added to a coordination database included in the global coordinator 20, the global coordinator 20 can access, schedule, plan, command, and control that system or subsystems. This enables complete and seamless integration of a new system or subsystem into the entire system 10. The architecture design allows for multi-dimensional expansion by adding any number of systems and by increasing the number of subsystems.

Inter-communications are accomplished through any number of commercial methods, including the Opportunistic Data protocol. This capability enables the global coordinator 20 to maintain oversight while also allowing autonomy to the varied systems or subsystems.

This automated and intelligent system frees operators to focus on more urgent or demanding functions, while enabling the system 10 to perform the mundane, routine, or complex activities. The combination of all of these capabilities brings synergy to moving process machinery, automated, autonomous control and guidance through a single intelligent global coordinator 20.

A benefit of a system that fuses the intelligent autonomous control with the automated guidance for a planned task is that it results in an unmanned machine that is capable of carrying out a complete job function without, or with only minimal, manpower input. It is also a system which, when more than one agent is involved, is capable of intelligently cooperating and negotiating an optimum solution to the work assignment under direction of a global coordinator. This increased efficiency of the system saves manpower labor costs, allows for highly repeatable performance, and also reduces human exposure to dangerous work environments. These system benefits provide value in a wide array of applications and potential commercial applications.

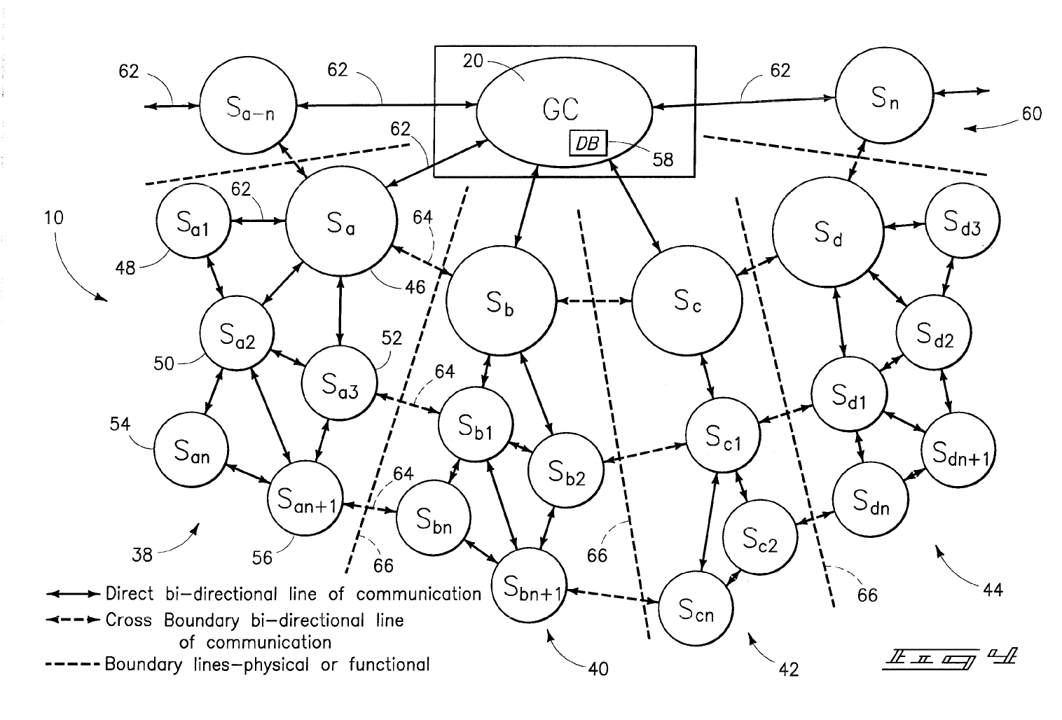

FIG. 4 is a block diagram in an alternative format illustrating the expandability and adaptability of the system of FIG. 1. As illustrated in FIG. 4, the global coordinator 20 is expandable and adaptable and can expand its coordination to an increased number of systems (e.g., 38, 40, 42, 44) or subsystems (e.g., 46, 48, 50, 52, 54, 56 are subsystems of system 38). In operation, information about a new system or subsystem is added to a coordination database 58 included in the global coordinator 20, and the global coordinator then accesses, schedules, plans, commands, and controls that new system or subsystems (e.g., system 60). This enables complete and seamless integration into the system 10. The architecture design allows for multi-dimensional expansion by adding any number of systems and by increasing the number of subsystems. This capability enables the global coordinator to maintain oversight but also allows autonomy to the various systems or subsystems. In FIG. 4, solid lines 62 with arrows indicate bi-directional lines of communication, dashed lines 64 with arrows illustrate cross boundary bi-direction lines of communication, and dashed lines 66 indicate boundary lines which may be either physical or functional.

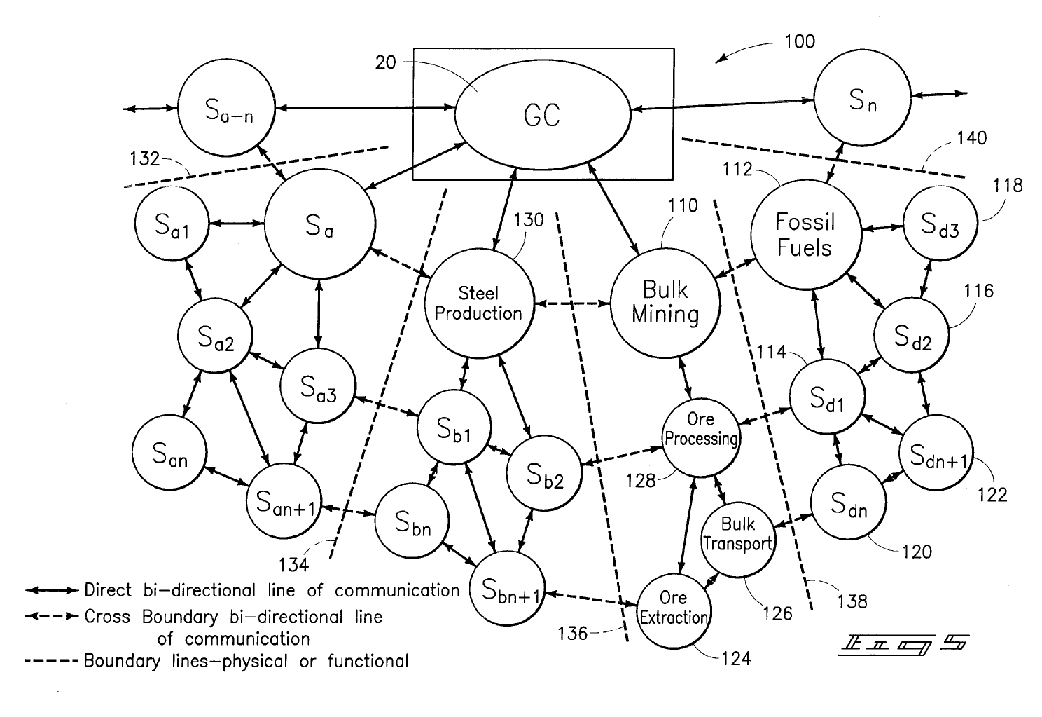

FIG. 5 is a block diagram of a system 100 in accordance with a specific example relating to bulk mining. In this example, a bulk mining system 110 is dependent on other industries or systems such as fossil fuels 112. Fossil fuels are needed by the bulk mining system 110 for operating equipment in the bulk mining system 110. The fossil fuels system 112 has several sub-processes or systems 114, 116, 118, 120, 122. Additionally other systems or industries may be dependent on bulk mining. In the embodiment of FIG. 5, a steel production system 130 is dependent on and interacts with the bulk mining system 110.

In the illustrated embodiment, the bulk mining system 110 includes three subsystems, an ore extraction subsystem 124, a bulk transport subsystem 126, and an ore processing subsystem 128. The global coordination of the system 100 and the architecture that includes the global coordinator 20 allows systems or subsystems 110, 112, 114, 116, 118, 120, 122, 124, 126, 128, 130 to communicate information, capabilities, and current status with each other.

Communications are functionally achieved across boundary lines 132, 134, 136, 138, and 140 through intelligent and opportunistic data transfer. The global coordinator 20 manages information, resources, capabilities, material flow, etc. This enables the system 100 to provide service, material, products, etc. just-in-time, thus optimizing entire industries. For example, steel production 130 may require an increase in processed ore and notify the global coordinator 20 which, in turn, notifies bulk mining 110 that an increase is necessary. Bulk mining 110 then notifies fossil fuels 112 that an increase in fuel is necessary, and so on.

Additionally, in the illustrated embodiment, as bulk mining 110 receives notification from the global coordinator 20 that an increase is needed, it can initiate changes to planning and coordination to increase production of ore, add or speed up transportation and extraction, etc.

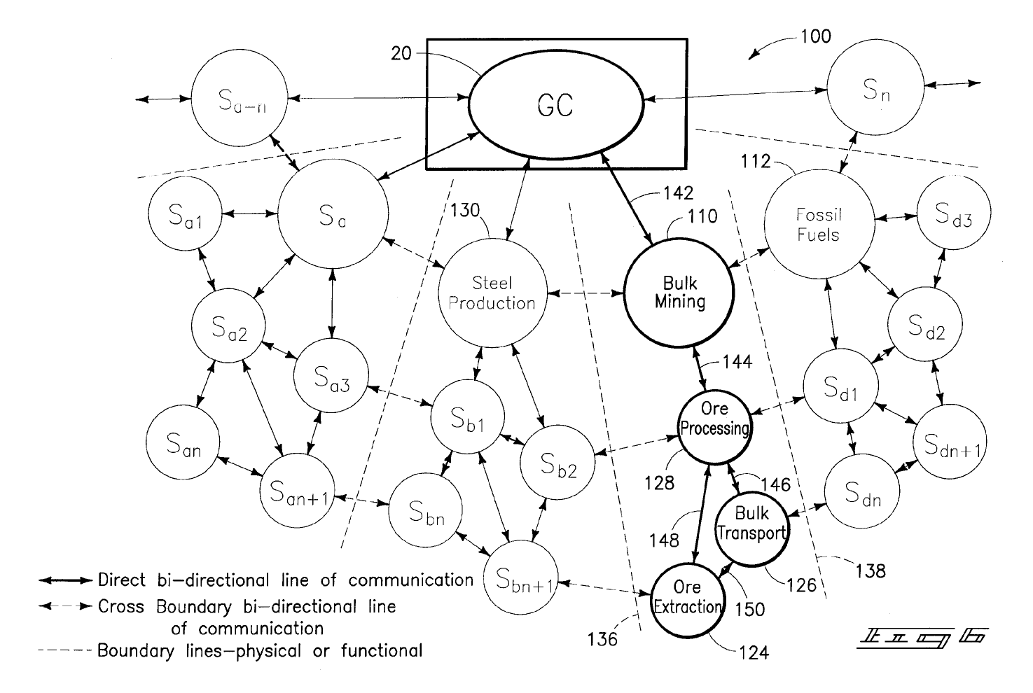

FIG. 6 is a block diagram focusing on an individual system included in the system of FIG. 5. More particularly, FIG. 6 focuses on the individual bulk mining system 110 and subsystems and shows ore processing subsystem 128, bulk transport subsystem 126, and ore extraction subsystem 124 in communications with one another and with the global coordinator 20. Solid lines 142, 144, 146, 148, and 150 indicate direct bi-directional lines of communication. In the embodiment of FIGS. 5 and 6, there are three main systems. Each system 110, 112, and 130 has the capability to apply specific planning and coordination for its unique capabilities and abilities. As such, the global coordinator 20 does not require, for example, detailed knowledge of how ore is processed, only that it is processed and at what rate. Ore processing subsystem 128 handles all of the details of processing ore from raw material. The ore processing subsystem 128 handles, for example, flow rates within its sphere while communicating to those processes, systems, and subsystems necessary to perform its task.

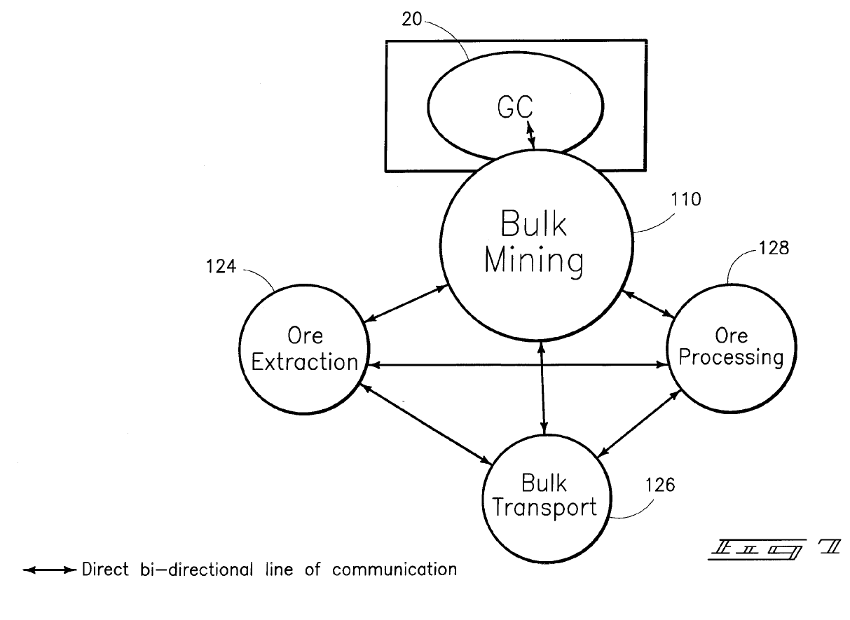

FIG. 7 is a block diagram illustrating communications between subsystems illustrated in FIG. 6. In the embodiment of FIG. 1, assume bulk mining 110 notifies bulk transport 126 that an increase in raw material is required. Bulk transport 126 notifies ore extraction 124 of the increased production rate. Bulk mining, ore extraction 124, and bulk transport 126 can be functionally or physically separated. Communications can be achieved between systems or subsystems without communicating to the global coordinator 20. For example, ore extraction 124 may notify ore processing 128 that a specific “vein” is showing signs of decrease, which may effect production. All new information is then sent to the global coordinator 20 which updates the coordination database 58 and optimizes all related activities associated with the new information.

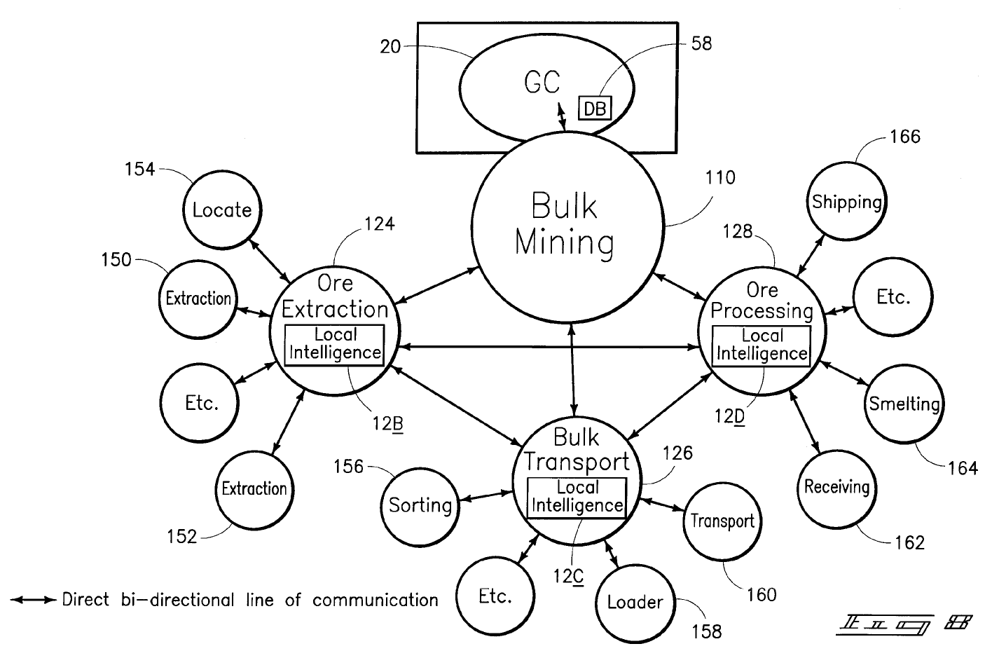

FIG. 8 is a block diagram illustrating details of subsystems included in the system of FIG. 7. Within each system is any number of subsystems. For example, the bulk mining system of FIGS. 6 and 7 includes subsystems for performing its operations or tasks. Such tasks include, for example, extraction 150, 152, locating 154, sorting 156, loading 158, transporting 160, receiving 162, smelting 164, shipping 166, etc. Like the bulk mining system or layer 110, each system does not necessarily require detailed information of subsystems, only access to the global coordinator 20. Each subsystem 124, 126, 128 contains local intelligence 12B, 12C, 12D (like local intelligence 12 of FIG. 1) for reliable operations.

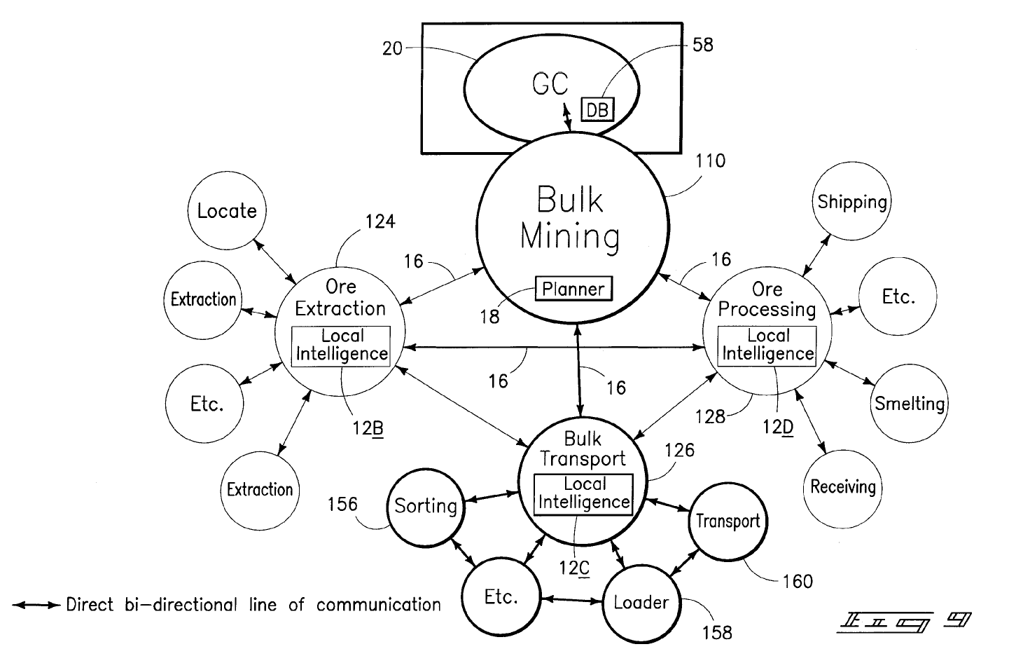

FIG. 9 is a block diagram illustrating further details of subsystems included in the system of FIG. 7 and communications between subsystems. Exploring the architecture further into the subsystems, it can be seen that all of the functions and capabilities aptly apply. For example, the transport subsystem 126 can share information with the loader 158, sorting 156, and other operations or tasks. Additionally, each subsystem knows the capabilities of all other subsystems and can use this information to optimize its own tasks. Knowledge sharing is achieved through the global coordinator 20 which keeps the coordination database 58 current. If new equipment is added to a subsystem, the subsystem planner 18 publishes specifications and capabilities of the new equipment. The new information then becomes available to all users or agents (e.g. subsystems). Agents can then decide if the new information is of value to their operations or tasks.

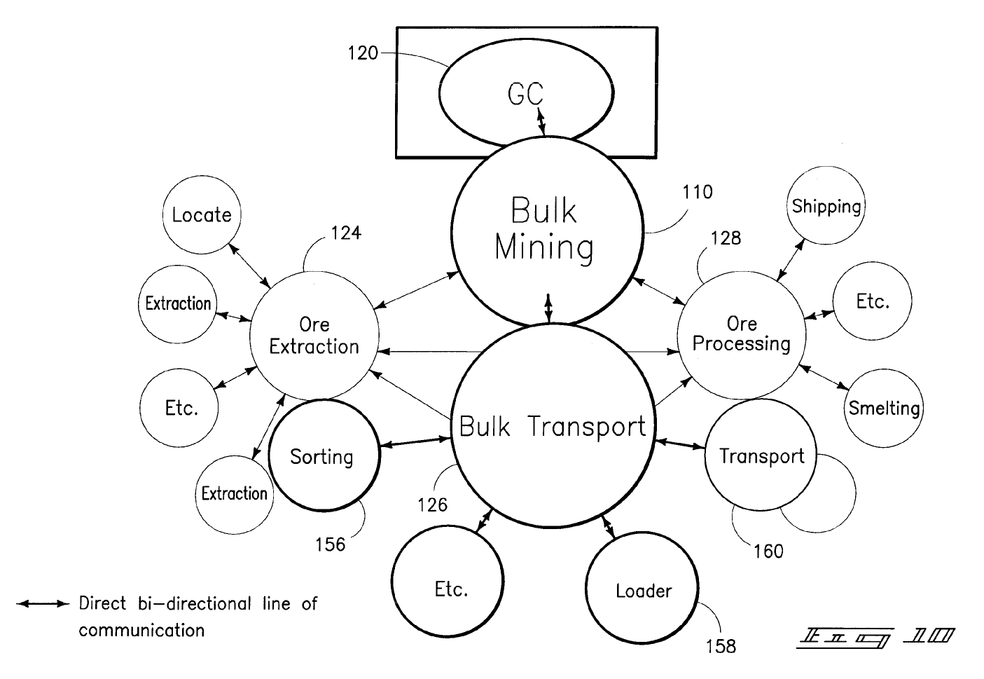

FIG. 10 is a block diagram illustrating communications between subsystems included in the system of FIG. 7. The system architecture seamlessly transports information to subsystems. For example, in the embodiment of FIG. 10, the transport subsystem 160 thinks it is communicating to the global coordinator 120. This occurs in a manner similar to how two computers on the Internet pass data back and forth. Users only know that information is passed back and forth, and are unaware of underlying steps that occur to assure data is successfully passed. In the illustrated embodiment, data is passed using intelligent communications 16 of FIG. 1, as described above, using a protocol such as opportunistic data protocol or some other appropriate protocol.

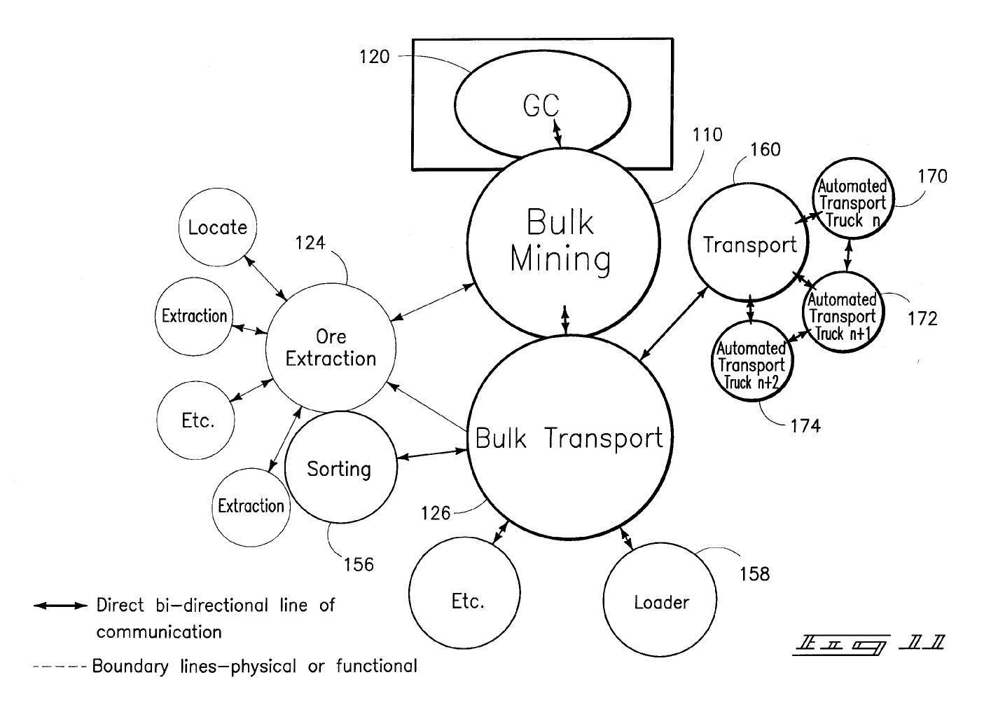

FIG. 11 is a block diagram illustrating additional subsystems included in a system. Each subsystem can have any number of further subsystems or agents associated with it. For example, in the embodiment of FIG. 11, transport system 160 has three automated transport trucks 170, 172, and 174.

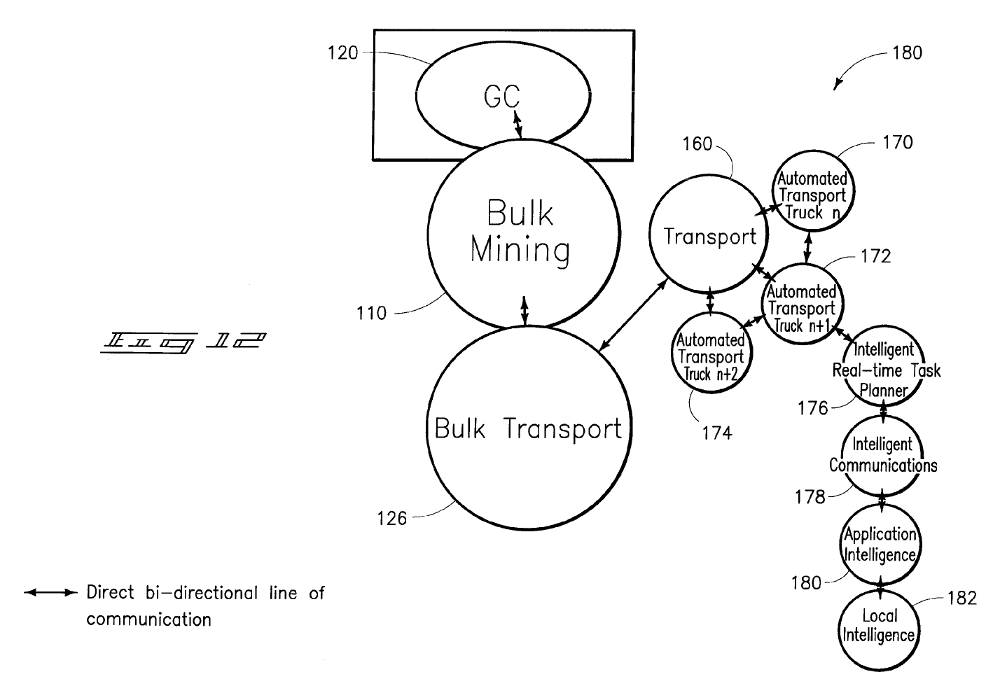

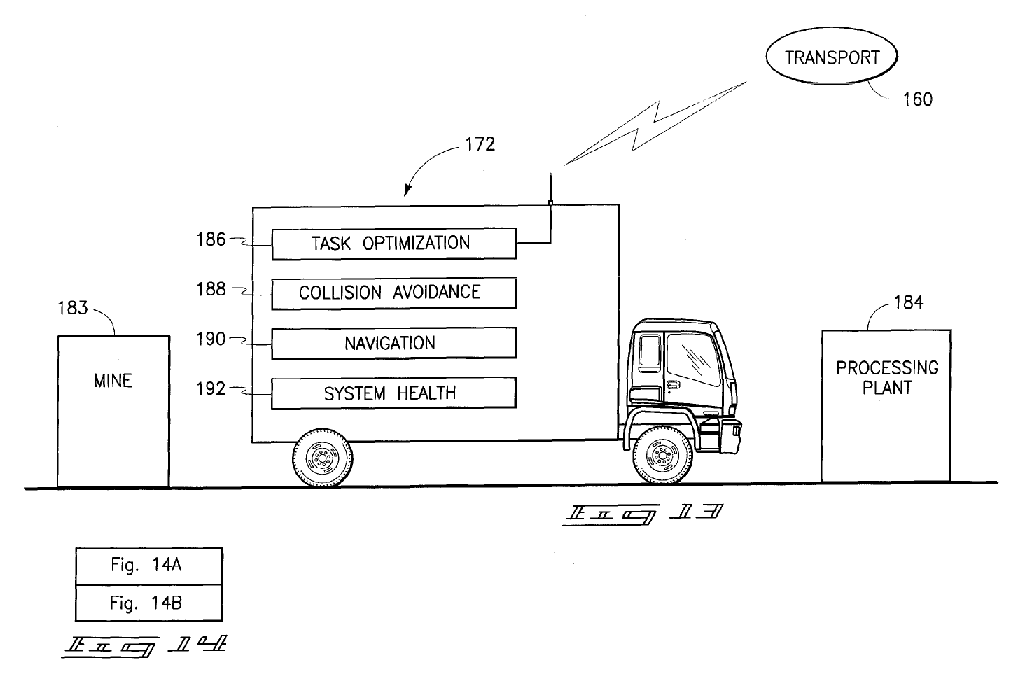

FIG. 12 is a block diagram similar to FIG. 11 but illustrating additional details for one of the subsystem shown in FIG. 11. More particularly, FIG. 12 shows more details of transport truck architecture 180 and its association with the bulk mining system 110. The design allows each individual agent to exploit its level of autonomy without being impacted by the over-arching control architecture. In the illustrated embodiment (see also FIG. 13), an automated transport truck 172 transports raw material from a mine 183 to a processing plant 184 using local collision avoidance 188, navigation 190, system health 192, and task optimization 186 (which define application intelligence and local intelligence) while maintaining access to the entire coordination database managed by the global coordinator 20. Likewise, the global coordinator 20 has the ability to notify or give tasks to systems, subsystems, and events, allowing individual agents to achieve optimal performance.

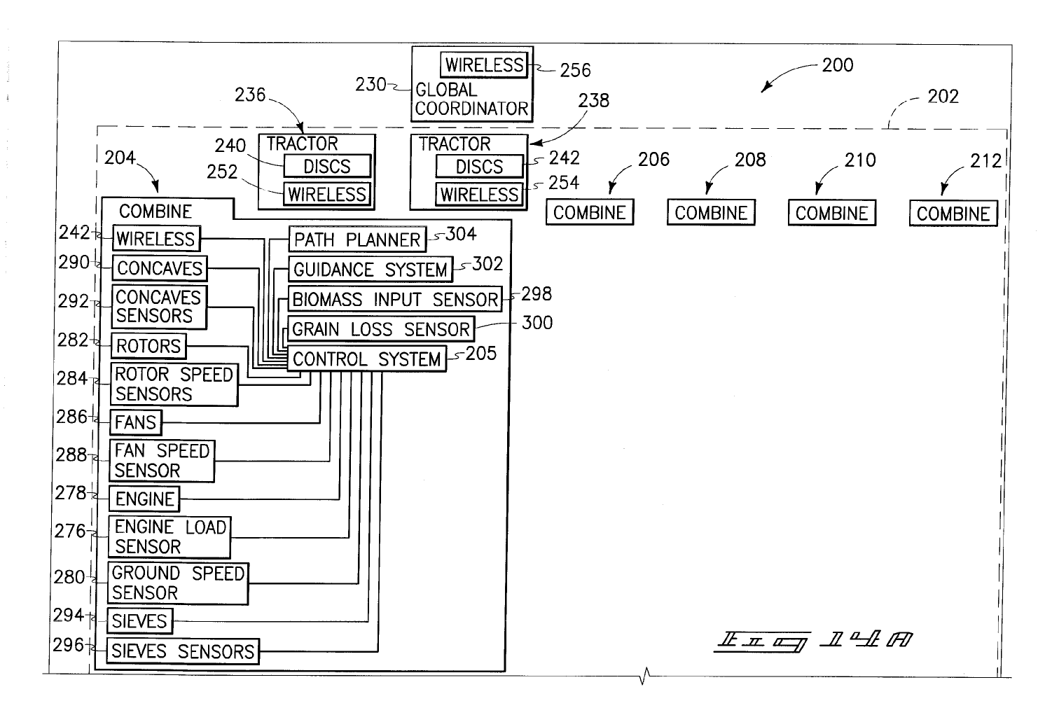

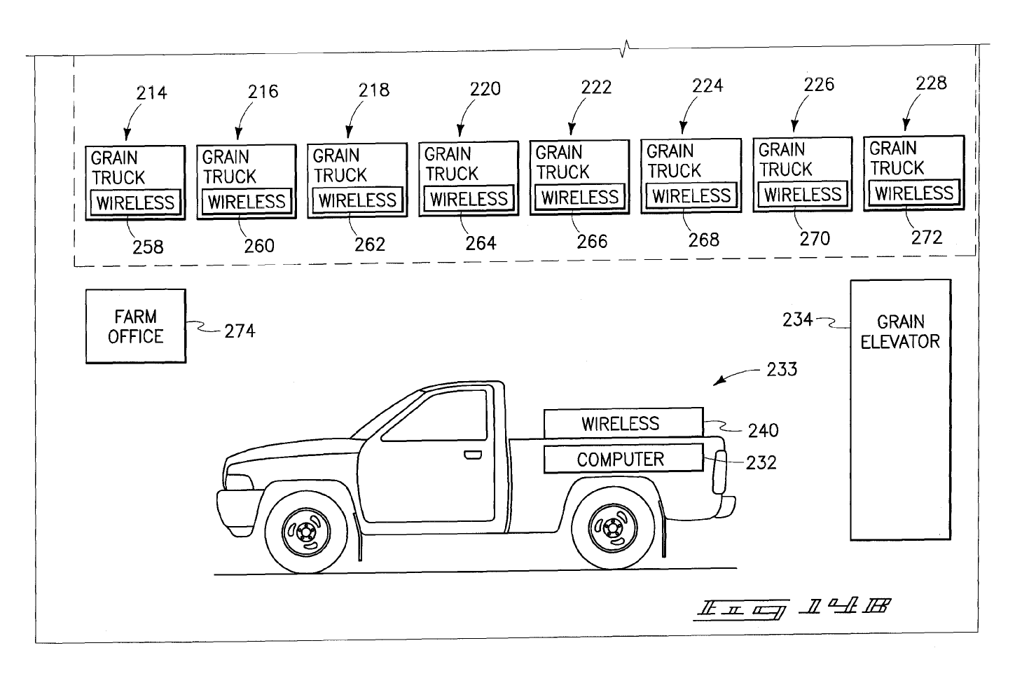

FIGS. 14A and 14B illustrate a specific example employing systems and methods for the autonomous control, automated guidance, and global coordination of agricultural machinery. More particularly, FIGS. 14A and 14B show a system 200 including a plurality of grain combines 204, 206, 208, 210, 212; grain trucks 214, 216, 218, 220, 222, 224, 226, and 228; a global coordinator 230; and a farm manager's computer 232. While other numbers of units could, of course, be employed, in the illustrated embodiment there are five combines and eight grain trucks. In the illustrated embodiment, a large field 202 is being harvested by the fleet of grain combines 204, 206, 208, 210, 212, and the combines are being tended by grain trucks 214, 216, 218, 220, 222, 224, 226, and 228. Details of only one combine 204 are shown for simplicity; however, combines 206, 208, 210, and 212 are the same or are substantially similar to combine 204 (e.g., they contain all or some subset of the components of combine 204). In the illustrated embodiment, when a grain truck 214, 216, 218, 220, 222, 224, 226, or 228 is full, it will haul the grain to a local elevator 234 to unload. In this particular example, the field 202 is also being tilled by some tractors 236 and 238 pulling discs 240 and 242 so that as the crop is harvested the field is disked in preparation for next spring's planting of the next crop. All of this is under the guidance of global coordinator 230.

In the illustrated embodiment, the computer 232 is a portable computer, and resides in the farm manager's vehicle 233. In alternative embodiments, the computer can be stationary or in other locations. The computer 232 has direct access to the global coordinator 230. More particularly, intelligent communications are included in the system 200. In the embodiment of FIGS. 14A and 14B, the global coordinator 230, and the farm manager's computer 232 have wireless communication capabilities, as do the grain combines 204, 206, 208, 210, 212, and grain trucks 214, 216, 218, 220, 222, 224, 226, and 228. For example, they may have wireless cards or chips or any other appropriate wireless communications devices 252, 254, 256, 258, 260, 262, 264, 266, 268, 270, 272 that use any appropriate protocol. In some embodiments, this communication capability may be limited in power, and range, and provide only the ability to communicate between subsystems by line-of-sight. During the harvest, the farm manager may be traveling around in the vicinity of the field 202 being harvested, and back and forth to and from the farm office 274 and the grain elevator 234, in vehicle 233.

Within each combine 204, 206, 208, 210, and 212, an autonomous control system 205 is running. The system 205 monitors the operating conditions in the combine. Load of the engine 278 is monitored using engine load sensor 276. Ground speed is monitored using ground speed sensor 280. The speed of rotors or cylinders 282 is monitored using rotor or cylinder sensors 284. The speed of fan 286 is monitored using fan speed sensor 288. The settings of concaves 290 are monitored by concaves sensors 292. The settings of sieves 294 are monitored by sieves sensors 296. The control system 205 additionally receives input from sensors such as a biomass input sensor 298, a grain loss or payload sensor 300, and/or other sensors throughout the combine. The autonomous control system 205 makes decisions that optimize the harvesting by adjusting operating conditions based on information received from the various sensors, for example. In some embodiments, the control system 205 defines an intelligent real time task planner 18, intelligent communications system 16, application intelligence 14, and local intelligence 12.

The decision-making of the control system 205 may be based on a predefined hierarchical decision tree, or it may be based on a predefined set of criteria-based decisions, or it may be based on user-defined directives. These decisions may result in resetting the rotor or cylinder speed, concave opening, the fan speed, and the ground speed (for example). Thus, in this scenario, the autonomous control system 205 within one combine is adjusting the operating conditions within that combine 204 based on what that combine is experiencing. Independent autonomous control systems are also running independently in the other combines 206, 208, 210, and 212, and each is adjusting its combine's operating conditions based on what that combine is experiencing.

While the combine 204, 206, 208, 210, or 212 is harvesting, it is guided by the local onboard automated guidance system 302. The path it follows is determined by the path planner 304 based on overall instructions from the global coordinator 230. The actual path traveled is controlled by the automated guidance system 302 that actually steers the combine along its path.

When the grain bin on a combine 204, 206, 208, 210, or 212 is full, the grain is unloaded into one of the grain trucks 214, 216, 218, 220, 222, 224, 226, or 228, either on-the-go with the grain truck driving along under the combine's grain unload spout, or while the combine is stopped and unloading into the stopped truck. Then the combine resumes harvesting, steered along a path controlled by the local automated guidance system 302 along the optimum path determined by the global coordinator 230. Having the grain truck nearby the combine when the combine is ready to unload is managed by the global coordinator 230.

When a grain truck 214, 216, 218, 220, 222, 224, 226, or 228 is loaded, it is ready to travel to the elevator 234 where it is unloaded and the grain is stored. In some embodiments, the truck is guided to the elevator 234, perhaps routed by the path planner 304, and dispatched by the global coordinator 230 to arrive at the elevator at a time when the elevator 234 is ready to receive the grain. Thus, the trucks no longer wait in a long line at the elevator 234 to be unloaded.

All the trucks 214, 216, 218, 220, 222, 224, 226, or 228 are overseen and controlled by the global coordinator 230, which makes sure there is always a truck available to unload grain when a combine fills, and which coordinates the trucks' schedules for unloading.

In the illustrated embodiment, the global coordinator 230 also instructs the tillage operation of tractors 236 and 238 and assigns the areas to be tilled based on successful completion of harvest in those areas, taking into account such things as possible ongoing travel across those areas by the combines 204, 206, 208, 210, 212 or trucks 214, 216, 218, 220, 222, 224, 226, or 228 carrying out their work, and the paths for the tractors to follow.

In the illustrated embodiment, the communication from each combine 204, 206, 208, 210, 212, passing information such as about how full it is, is passed directly to the global coordinator 230 if in transmission range, or opportunistically as the combine 204, 206, 208, 210, 212 comes into the field of transmission of a grain truck 214, 216, 218, 220, 222, 224, 226, or 228 or another combine 204, 206, 208, 210, 212, from which the information is relayed on opportunistically by those machines to the global coordinator 230. The global coordinator 230 at some point assigns a grain truck 214, 216, 218, 220, 222, 224, 226, or 228 to tend the filled grain combine 204, 206, 208, 210, 212, so it can be unloaded when full, and also coordinates the truck's dispatch for unloading, taking into consideration things such as the status of the unload queue at the elevator 234 and travel time.

Likewise, in some embodiments, other communication among the pieces of equipment is opportunistic as each individual piece of equipment travels within the field of transmission of other pieces of equipment. Thus the information is passed back to the global coordinator 230 as the farm manager drives within the area of any equipment.

In the illustrated embodiment, as the work continues, the global coordinator 230 makes decisions for individual pieces of equipment based on the knowledge the global coordinator 230 develops from the complete information set the global coordinator 230 has on all the pieces of equipment. That is, the global coordinator 230 is the entity who sees the whole system, unlike any other individual piece of the system, which only sees what it is experiencing and may be unaware of what the other individual subsystem is seeing. Thus, the global coordinator 230 may, as an example, reassign the path to be followed by one combine when another combine is down for repairs, taking into account the geography of the field and the header cutting widths of each individual combine, or it may reassign or shut down a combine because the grain trucks are filling late in the day and the global coordinator 230 does not want to leave grain trucks loaded overnight after the elevator 234 closes for the night.

Note the difference in the breadth of the two specific scenarios described above. The agricultural scenario is a few miles wide while the bulk mining scenario may cover several states, for example, or cross national borders. In alternative embodiments, the agricultural scenario may be replicated across several to many farms in a region, and the global coordinator optimizes assignment of limited numbers of machines to accomplish harvest.

The adaptability of the system to many alternative scenarios is readily apparent.

This automated and intelligent system 10 frees operators to focus on more urgent or demanding functions, while enabling the system 10 to perform various mundane, routine, or complex activities. The combination of all of these capabilities brings synergy to moving process machinery, automated, autonomous control and guidance through a single global coordinator 20.

In compliance with the patent statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. A control system for controlling and coordinating a plurality of moving machines, the system comprising:
a global coordinator; and
a plurality of subsystems controlled by the global coordinator, respective subsystems including:
an intelligent real-time task planner including a job planner and job optimizer;
intelligent communications hardware configured to allow communications between the subsystem and the global coordinator or another subsystem;
an application intelligence system configured to control functions related to a specific task a machine has been given; and
a local intelligence system coupled to sensors and actuators of one of the machines and configured to control automated functions for the machine.

2. A control system in accordance with claim 1 and including an intelligent communications system configured to coordinate opportunistic communications between a subsystem and the global coordinator or another subsystem.

3. A control system in accordance with claim 2 wherein the intelligent communications system is configured to coordinate opportunistic communications by causing machines to pass a message from one machine to the other when they come within communications range.

4. A control system in accordance with claim 1 wherein the local intelligence is coupled to at least one sensor in a machine for sensing at least one of physical objects, chemicals, radiations, and electromagnetic signals, and wherein the local intelligence is configured to use the information from the sensor to protect the machine.

5. A control system in accordance with claim 1 wherein the local intelligence is coupled to at least one sensor in a machine for sensing at least one of chemicals, physical objects, radiation, and electromagnetic signals, and wherein the local intelligence is configured to use the information from the sensor to make decisions on partitioning work processes within a particular machine.

6. A control system in accordance with claim 1 wherein the local intelligence guides a particular machine through its environment.

7. A control system in accordance with claim 1 wherein the local intelligence guides a particular machine for movement relative to the ground.

8. A control system in accordance with claim 1 wherein the application intelligence is configured to interact with payload hauled by a machine, and with a sensor configured to measure a parameter related to payload.

9. A control system in accordance with claim 1 wherein the application intelligence is configured to optimize the settings of concaves of a combine.

10. A control system in accordance with claim 1 wherein the application intelligence is configured to optimize rotor speed of a combine.

11. A control system in accordance with claim 1 wherein the application intelligence is configured to optimize fan speed of a combine.

12. A control system in accordance with claim 1 and configured to optimize a bulk mining process.

13. A control system in accordance with claim 1, wherein the subsystems include an ore extraction subsystem, wherein the control system further includes a bulk transport subsystem including local intelligence, and an ore processing subsystem including local intelligence.

14. A control system in accordance with claim 13, wherein the bulk transport subsystem includes automated transport vehicles.

15. A method of controlling and coordinating a plurality of moving machines, the method comprising:
providing a global coordinator;
controlling a plurality of subsystems using the global coordinator; and for at least one of subsystems:
planning and optimizing jobs;
communicating between the subsystem and the global coordinator or another subsystem;
controlling functions related to a specific task a machine in the subsystem has been given; and
controlling automated functions for the machine.

16. A method in accordance with claim 15 and further comprising performing opportunistic communications between a subsystem and the global coordinator or another subsystem.

17. A method in accordance with claim 16 and further comprising performing opportunistic communications by causing machines to pass a message from one machine to the other when they come within communications range.

18. A method in accordance with claim 15 wherein controlling automated functions comprises sensing at least one of physical objects, chemicals, radiations, and electromagnetic signals.

19. A method in accordance with claim 15 wherein controlling automated functions comprises sensing at least one of chemicals, physical objects, radiation, and electromagnetic signals, and using the information from the sensor to make decisions on partitioning work processes within a particular machine.

20. A method in accordance with claim 15 wherein controlling automated functions comprises guiding a particular machine through its environment.

21. A method in accordance with claim 15 wherein controlling the automated functions comprises guiding a particular machine for movement relative to the ground.

22. A method in accordance with claim 15 wherein controlling functions related to a specific task comprises sensing a parameter related to a payload hauled by a machine.

23. A method in accordance with claim 15 wherein controlling functions related to a specific task comprises optimizing the settings of concaves of a combine.

24. A method in accordance with claim 15 wherein controlling functions related to a specific task comprises optimizing rotor speed of a combine.

25. A method in accordance with claim 15 wherein controlling functions related to a specific task comprises optimizing fan speed of a combine.

26. A method in accordance with claim 15 and configured to optimize a bulk mining process.

27. A method in accordance with claim 15, wherein the subsystems include an ore extraction subsystem having a bulk transport subsystem and an ore processing subsystem.

28. A method in accordance with claim 27, wherein the bulk transport subsystem includes automated transport vehicles.

29. A control system for controlling and coordinating a plurality of moving machines, the system comprising:
a global coordinator;
a first subsystem controlled by the global coordinator, the first subsystem including:
a plurality of automated moving machines, the machines including sensors and actuators, including actuators for automated guidance and movement; and
a local control system, under guidance of the global coordinator coupled to the sensors and actuators of one of the machines and configured to control automated functions for the machine, including automated guidance and movement;
a second subsystem controlled by the global coordinator, the second subsystem including:
a plurality of automated moving machines, the machines of the second subsystem including sensors and actuators, including actuators for automated guidance and movement; and
a second local control system, under guidance of the global coordinator coupled to the sensors and actuators of one of the machines of the second subsystem and configured to control automated functions for the machine, including automated guidance and movement; and
an intelligent communications system configured to allow communications between the first subsystem and the global coordinator or the second subsystem.

30. A control system in accordance with claim 29 wherein the intelligent communications system is configured to coordinate opportunistic communications between the first subsystem and the global coordinator or the second subsystem.

31. A control system in accordance with claim 30 wherein the intelligent communications system is configured to coordinate opportunistic communications by causing machines to pass a message from one machine to the other when they come within communications range.

32. A control system in accordance with claim 29 wherein at least one of the machines of the first subsystem includes a sensor for sensing at least one of physical obstacles, chemicals, radiations, and electromagnetic signals, the local control system of the first subsystem being coupled to the at least one sensor and being configured to use information from the sensor to protect the machine.

33. A control system in accordance with claim 29 wherein at least one of the machines of the first subsystem includes a sensor and the local control system of the first subsystem is configured to use the information from the sensor to make decisions on partitioning work processes within a particular machine.

34. A control system in accordance with claim 29 wherein the local control system of the first subsystem guides a particular machine of the first subsystem through its environment.

35. A control system in accordance with claim 29 wherein the local control system of the first subsystem guides a particular machine in the first subsystem for movement relative to the ground.

36. A control system in accordance with claim 29 and further comprising a sensor configured to measure a parameter related to payload of a machine of the first subsystem, and wherein the local control system of the first subsystem is configured to interact with the payload in response to the payload parameter sensor.

37. A control system in accordance with claim 29 wherein the first subsystem includes a combine having concaves having selectable settings and wherein the local control system is configured to optimize the settings of concaves of a combine.

38. A control system in accordance with claim 29 wherein the first subsystem includes a combine having rotors having selectable speeds and wherein the local control system is configured to optimize rotor speed of a combine.

39. A control system in accordance with claim 29 wherein the first subsystem includes a combine and the local control system of the first subsystem is configured to optimize fan speed of the combine.

40. A control system in accordance with claim 29 and configured to optimize a bulk mining process.

41. A control system in accordance with claim 29, wherein the first subsystem is an ore extraction subsystem, wherein the second subsystem is a bulk transport subsystem, and wherein the control system further includes an ore processing subsystem.

42. A control system in accordance with claim 41, wherein the bulk transport subsystem includes automated transport vehicles.
